(19) United States
(12) Patent Application Publication
(10) Pub. No.: US 2004/0186815 A1
(43) Pub. Date: Sep. 23, 2004

(54) Method for accommodating missing descriptor and property data while training neural network models

(76) Inventor: Thomas P. Stockfisch, Escondido, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/742,626

(22) Filed: Dec. 19, 2003

Related U.S. Application Data
(60) Provisional application No. 60/435,946, filed on Dec. 20, 2002.

(51) Int. Cl. G06F 15/18; G06G 7/00; G06E 3/00; G06E 1/00

(52) U.S. Cl. 706/16; 706/21

(57) ABSTRACT

Systems and methods are described for training a neural network with a set of training items that contains items missing one or more X descriptors and/or one or more Y property values. Missing property values are accommodated by not back propagating error due to predictions of the missing property values. Missing descriptors are accommodated by first providing initial estimates for the missing descriptors. The missing descriptors are predicted in replicated output nodes along with properties of interest. Error is then back propagated all the way to the missing descriptor input nodes in order to adjust the estimates. Iteration can provide optimized estimates of the missing descriptors along with an optimized neural network. Missing descriptors in new items whose properties of interest are to be predicted can similarly be accommodated.

### RELATED APPLICATION

This application claims priority to provisional application No. 60/435,946, filed on Dec. 20, 2002, which is hereby incorporated by reference.

### BACKGROUND OF THE INVENTION

1. Field of the Invention

This invention relates to methods and systems of predicting properties of molecules.

2. Description of the Related Art

A physical item's unknown conditions can often be predicted based on the item's known conditions. Disease diagnosis is one simple example. If a patient has symptom A, and has symptom B, but does not have symptom C, then it may be predicted that the patient has some particular disease. In this example, the physical item's (the patient's) three known conditions (have symptom A, have symptom B, not have symptom C) are used to predict an unknown condition (that the patient has some particular disease). The conditions that are known or easy to measure or calculate are often called descriptors or X variables. The conditions that are unknown or difficult to measure or calculate, and that are believed to be related to the descriptors, are often called properties or Y variables.

There are several methods available for predicting unknown properties of an item based on its known descriptors. Commonly used methods include user-defined algorithms, decision trees, and neural networks. The present invention relates primarily to neural networks.

Neural networks are described generally in U.S. Pat. No. 5,113,483 (Keeler et al.); U.S. Pat. No. 5,167,009 (Skeirik); U.S. Pat. No. 5,271,068 (Ueda et al.); U.S. Pat. No. 5,276,771 (Manukian et al.); U.S. Pat. No. 5,384,895 (Rogers et al.); U.S. Pat. No. 5,555,317 (Anderson); U.S. Pat. No. 5,636,291 (Bellegarda et al.); and U.S. Pat. No. 5,638,491 (Moed), all of which are hereby expressly incorporated by reference.

More particularly, techniques useful for predicting the properties of chemical compounds, which can include the use of neural networks, are described in U.S. Pat. No. 6,081,766 (Chapman et al.); U.S. Pat. No. 5,526,281 (Chapman et al.); U.S. Pat. No. 5,025,388 (Cramer, III et al.); U.S. Pat. No. 5,260,882 (Blanco et al.); and U.S. Pat. No. 5,265,030 (Skolnick et al.); and in Zupan et al., Neural Networks in Chemistry and Drug Design, 2^{nd} ed., Wiley-VCH (1999); all of which are hereby expressly incorporated by reference. In some cases, neural networks are used to predict a single Y property for a set of X descriptors, and in some cases, they are used to predict two or more Y properties from a set of X descriptors.

When training a neural network, it is often desirable to use a large number of training items that span a wide range of X characteristics. However, one shortcoming of existing neural network technology is that known information about many potential training items is incomplete such that some X and/or Y variables are not known for some compounds. Conventionally, compounds with missing Y variables are not used at all to train a predictive neural network. Techniques for dealing with missing X descriptors involve some way of assigning values to the missing X descriptors, either by selecting the mean of the known X values from other training items, or attempting to correlate the unknown X value with other known X values of the training item.

Accordingly, there exists an unmet need in the art for a method of accommodating missing X and/or Y data while training a neural network such that training items having incomplete data can still be used to ultimately generate a neural network that is more robust and accurate than a neural network that could be created by simply ignoring those training items.

### SUMMARY OF THE INVENTION

In one embodiment, the invention comprises a method of constructing a neural network comprising a set of property prediction outputs and a set of descriptor inputs, the method comprising updating connection weights of the neural network using a training set of physical items, wherein at least some of the physical items of the training set have one or more undefined properties corresponding to at least one output of the neural network. In some embodiments, at least some of the physical items of the training set have one or more undefined descriptors corresponding to at least one input of the neural network. Some embodiments additionally comprise optimizing estimates for undefined descriptors of the training set of physical items.

One aspect of the present invention is a method of training a neural network, wherein the neural network operates to provide predictions of at least one attribute of interest of a physical item, wherein the physical item has one or more measured or computed descriptors representative of one or more physical characteristics of the physical item, and wherein the physical item has one or more unknown properties of interest which have not been physically measured or otherwise previously determined, the neural network including a plurality of layers, each layer including one or more nodes, wherein the first layer includes one or more input nodes that are configured to receive as input the one or more descriptors, wherein the last layer includes one or more output nodes that are configured to output predictions of values for the one or more unknown properties of interest, and wherein one or more layers between the first and last layers includes one or more hidden nodes, each hidden node in a layer receiving as input the output of nodes in the immediately preceding layer and producing as output the result of a function of the output of nodes in the immediately preceding layer and one or more connection weights, the method including providing a set of training items to the neural network, the items including one or more physically measured or previously determined descriptors, representing physical characteristics of the items, and physically measured or previously determined values for one or more properties of interest, representing physical properties of the items, wherein a value for at least one property of interest has not been physically measured or otherwise previously determined for at least one item.

Another aspect of the present invention is a method of training a neural network, the neural network operating to provide predictions of at least one attribute of interest of a physical item, wherein the physical item has one or more measured or computed descriptors representative of one or more physical characteristics of the physical item, and wherein the physical item has one or more unknown properties of interest which have not been physically measured or otherwise previously determined, the neural network including a plurality of layers, each layer including one or more nodes, wherein the first layer includes one or more input nodes that are configured to receive as input the one or more descriptors, wherein the last layer includes one or more output nodes that are configured to output predictions of values for the one or more unknown properties of interest, and wherein one or more layers between the first and last layers include one or more hidden nodes, each hidden node in a layer receiving as input the output of nodes in the immediately preceding layer and producing as output the result of a function of the output of nodes in the immediately preceding layer and one or more connection weights, the method including the steps of: providing a set of training items, the items including one or more physically measured or previously determined descriptors, representing physical characteristics of the items, and one or more physically measured or previously determined values for one or more properties of interest; applying the one or more physically measured or previously determined descriptors of said set of items to the input nodes of the neural network; receiving as output from the output nodes a set of predicted values for properties of the set of training items; comparing only a subset of the set of predicted values with corresponding values in the physically measured or previously determined values; and adjusting the connection weights based on the comparing step.

Another aspect of the present invention is a method of training a neural network, the neural network operating to provide predictions of at least one attribute of interest of a physical item, wherein the physical item has one or more measured or computed descriptors representative of one or more physical characteristics of the physical item, and wherein the physical item has one or more unknown properties of interest which have not been physically measured or otherwise previously determined, the neural network comprising a plurality of layers, each layer including one or more nodes, wherein the first layer includes one or more input nodes that are configured to receive as input the one or more descriptors, wherein the last layer includes one or more output nodes that are configured to output predictions of values for the one or more unknown properties of interest, and wherein one or more layers between the first and last layers include one or more hidden nodes, each hidden node in a layer receiving as input the output of nodes in the immediately preceding layer and producing as output the result of a function of the output of nodes in the immediately preceding layer and one or more connection weights, the method including providing a set of training items to the neural network, the items comprising one or more physically measured or previously determined descriptors, representing physical characteristics of the items, and physically measured or previously determined values for one or more properties of interest, representing physical properties of the items, wherein at least one descriptor has not been measured or otherwise previously determined for at least one item.

Another aspect of the present invention is a method of training a neural network, the neural network operating to provide predictions of at least one attribute of interest of a physical item, wherein the physical item has one or more measured or computed descriptors representative of one or more physical characteristics of the physical item, and wherein the physical item has one or more unknown properties of interest which have not been physically measured or otherwise previously determined, the neural network comprising a plurality of layers, each layer including one or more nodes, wherein the first layer includes one or more input nodes that are configured to receive as input the one or more descriptors, wherein the last layer includes one or more output nodes that are configured to output predictions of values for the one or more unknown properties of interest, and wherein one or more layers between the first and last layers comprise one or more hidden nodes, each hidden node in a layer receiving as input the output of nodes in the immediately preceding layer and producing as output the result of a function of the output of nodes in the immediately preceding layer and one or more connection weights, the method including the steps of: providing a set of training items, the items including one or more physically measured or previously determined descriptors, representing physical characteristics of the items, and one or more physically measured or previously determined values for one or more properties of interest; applying the one or more physically measured or previously determined descriptors of the set of items to the input nodes of the neural network; applying an initial estimate for a descriptor corresponding to a characteristic of an item in the set of training items to one of the input nodes; receiving as output from said output nodes a set of predicted values for properties of the set of training items; comparing the set of predicted values with corresponding values in the one or more physically measured or previously determined values; and the step of adjusting the initial estimate based on the comparing.

Still another aspect of the present invention is a method of predicting values for one or more properties of interest of a physical item, the properties of interest representing physical properties of the item, the item including a plurality of descriptors representing one or more physical characteristics of the item, the method including the steps of: providing a neural network configured to receive as input values for the plurality of descriptors and provide as output values for the one or more properties of interest; providing to the neural network measured or computed values for at least one of said plurality of descriptors, wherein values for one or more other of the plurality of descriptors have not been physically measured or otherwise previously determined; and the step of receiving as output from the neural network predicted values for the one or more properties of interest.

A final aspect of the present invention is a computer implemented system for training a neural network for predicting one or more properties of interest of a physical item, said system including: a memory storing a set of descriptors and a set of values for the properties of interest for a subset of a set of training physical items, wherein the set of descriptors and the set of values for the properties were physically measured or previously determined, the memory also storing at least one descriptor and values for at least one property of interest for at least one of the set of training items not part of the subset, wherein at least one descriptor or at least one property of the at least one training item is not stored in the memory; a neural network calculation module operative to receive as input the set of descriptors and at least one descriptor and calculate predicted values for the properties of interest; a comparison module operative to compare the predicted values with the corresponding set of values and the values for at least one property; and a connection weight adjustment module operative to adjust connection weights of the neural network based on output from the comparison module.

### BRIEF DESCRIPTION OF THE DRAWINGS

FIG. 1 illustrates one example of a neural network structure.

FIG. 2 illustrates the anatomy of a node in a neural network.

FIG. 3 illustrates prediction error observed for a training set and a monitor set.

FIG. 4 depicts a flowchart illustrating a method for accommodating a missing Y value.

FIG. 5 illustrates replicated neural network architecture used to accommodate a missing X value.

FIG. 6 depicts a flowchart illustrating a method for accommodating a missing X value.

FIG. 7 illustrates a computer-implemented system for accommodating missing Y and X values.

### DETAILED DESCRIPTION OF THE PREFERRED EMBODIMENT

One embodiment of the present invention is a method of training a neural network with training items that include some items with missing or unknown X descriptors. Another embodiment of the present invention is a method of training a neural network with training items that include some items with missing or unknown Y values.

Another embodiment of the present invention is a neural network created using a training set having incomplete X data, incomplete Y data, or both. Another embodiment of the present invention is a method of using such a neural network, preferably in the prediction of properties of chemical compounds.

A further embodiment of the present invention is an inverse QSAR process. This refers to a process in which a user can start with one or more desired Y properties, and can then use a neural network to predict the X values that candidate molecules or formulations are likely to have. From there, the user can determine the various structures of the good candidate molecules or the ingredients and relative amounts which are in turn likely to exhibit the originally desired Y properties. Such molecules can then be synthesized, isolated, or designated for further study and/or development.

Neural Networks Generally

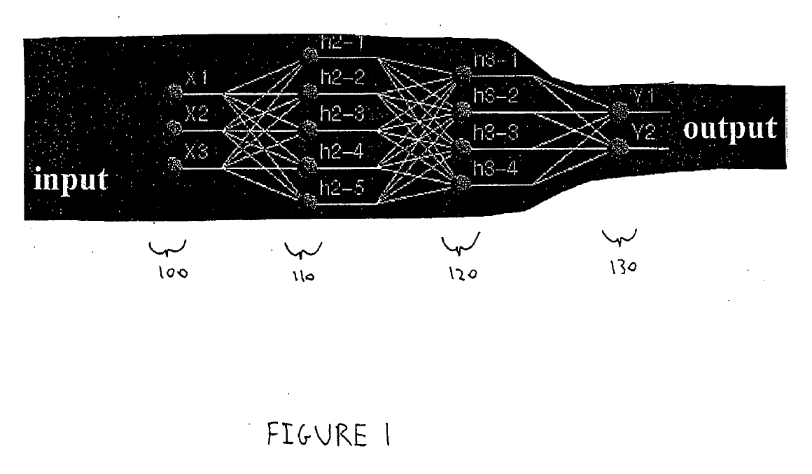

An example of a neural network is depicted in FIG. 1. This network comprises four layers of nodes. The nodes in first layer 100 are input nodes where X descriptors X1, X2, and X3 are provided to the network. The last layer 130 contains output nodes where predictions of values for Y properties Y1 and Y2 are output from the network. Layers 110 and 120 contain hidden nodes. Nodes in each layer receive as input the output from all the nodes in the immediately preceding layer. Thus, for example, hidden node h2-1 receives as input the output from input nodes X1, X2, and X3, which are the actual values for the X descriptors. Similarly, hidden node h3-1 receives as input the output of all the hidden nodes in layer 110.

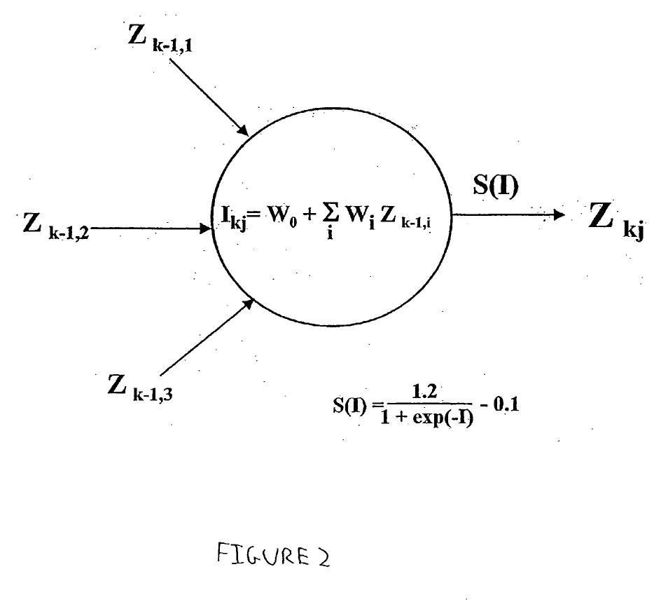

The anatomy of a particular node j in layer k of a neural network is depicted in FIG. 2. The node in FIG. 2 receives as input Z_{k-1,1}, Z_{k-1,2}, and Z_{k-1,3}, which represent the output from nodes 1 through 3 of layer k-1. In other words, the node in FIG. 2 receives as input the output of nodes in the immediately preceding layer. The node in FIG. 2 performs calculations using the values of the inputs Z_{k-1,1}, Z_{k-1,2}, and Z_{k-1,3}. In general, the calculations performed by a node involve finding the value of a function that combines all of the inputs using a series of connection weights (wᵢ) for each input. In the embodiment of FIG. 2, the node sums the product of the connection weights and the inputs. A bias weight W₀ may also be included. After the inputs to a node have been combined using connection weights, the obtained value may be further transformed using an additional function. In the node in FIG. 2, the function S(I) is applied to finally obtain the output of the node, Zₖⱼ.

Conventional training of a neural network involves supplying a set of training items that have known X descriptors and Y properties. The X descriptors are applied to the input nodes of the network and the neural network operates to calculate predicted values for Y properties for the set of training items. The difference between the predicted and known Y values is used to calculate an error function. The connection weights of the neural network are then adjusted in an attempt to minimize the error function. In one embodiment, the connection weights are adjusted using well known back-propagation of error methods, described in more detail below. Additional iterations can be run to further minimize prediction error. Each additional iteration involves predicting values for the Y properties using the connection weights as adjusted based on the error function of the previous iteration.

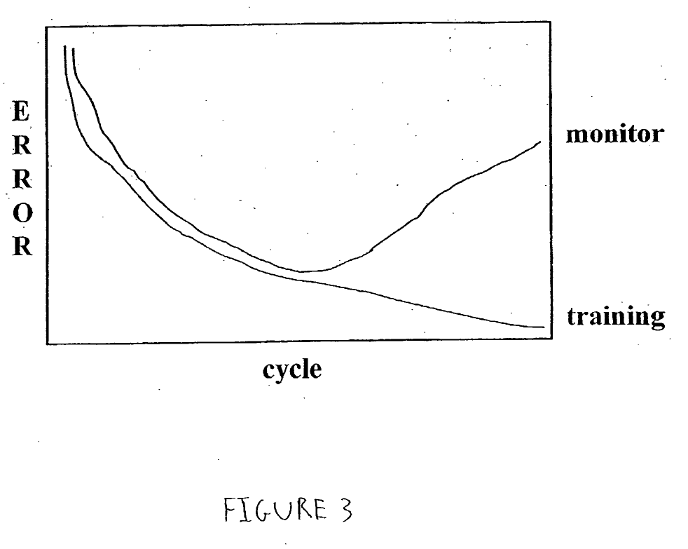

As training proceeds, the output of the network typically becomes an increasingly more complicated function of its inputs. To avoid an overly complicated mapping, the error can be monitored in a separate set of test items during training. The test set contains additional items having known X descriptors and known values for Y properties, but which are not used for the actual training process of iterative weight adjustment. Error between predicted values for the test set's Y properties and the known values are monitored during the training iterations. When this error begins to increase systematically instead of decrease, training is normally halted. FIG. 3 depicts the typical observed error for the training and test sets during neural network training. The error for the training set continues to decrease as the number of iterations increase. However, the error for the test set reaches a minimum and then increases. It is this minimum that indicates that the optimum number of iterations for training the neural network has been reached.

The mathematics of the network and the training process can be represented in a form that focuses on what happens at each node. In the equations that follow, L is the number of layers, mₗ is the number of nodes in layer l, wₗᵢⱼ is the weight applied to the jₜₕ input to the i^{th} node in layer l, w_{li( )} is a “bias” weight, Zₗᵢ is the output of the ith node in layer l, Zₗᵢ is Xᵢ, Z_{l( )} is identically 1 (for bias), Yᵢ is the desired (known) output, Y′ᵢ is the network's prediction of the i^{th} output, and exp( ) is the exponential function.

With these definitions,

Zₗᵢ=σ(Iₗᵢ), (1)

where

σ(I)=1/(1+exp(−I)) (2)

and

Iₗᵢ=Σⱼ₌₀^{ml-1}wₗᵢⱼZₗ₋₁ⱼ. (3)

For one hidden layer the i^{th} network output is therefore

Y′ᵢ=σ(Σⱼ₂₌₀^{m}^{₂}w₃ᵢⱼ_{₂}τ(Σⱼ_{₁}₌₀^{m}^{₁}w₂ⱼ_{₂}ⱼ_{₁}Xⱼ_{₁})) (4)

where j₁ and j₂ are indices running over the nodes of the first and second layers, respectively.

Training the network consists of minimizing the objective function

F=Σ_{training set}Σ_{I=0}^{m}ₗCᵢ(Y′ᵢ−Yᵢ)² (5)

with respect to the wₗᵢⱼ where Cᵢ is the miscalculation cost. To accomplish this task efficiently, an analytic first derivative of F is available in terms of a “local error” term, δ, given by

δ_{Li}=(Yᵢ−Y′ᵢ)dσ(I_{Li})/dI (6)

for the output layer, and

δ_{l-1,i}=(dσ(I_{l-1,i})/dI)Σⱼ₌₀^{m}^{ₗ}wₗᵢⱼδ_{I,j} (7)

for the other layers.

This gives

−Σ_{training set}δₗᵢZ_{l-1,j} (8)

for the derivative of F with respect to the wₗᵢⱼ.

Many algorithms for minimizing a function are available given a method for evaluating its first derivative. For example, steepest descent, conjugate gradient, or BFGS may be used. The training process thus involves an iterative reduction in total error over the training set by iteratively modifying the weights using values for the slope of F as a function of each weight in the network as defined by the formulas 6, 7, and 8 above so as to reduce the value of the function F

Neural networks can be configured to produce predictions for categorical Y properties. Categorical Y properties are those that have non-numeric values such as “active” or “not-active.” In other embodiments, neural networks are configured to produce predictions of numerical Y properties, such as a value for predicted binding strengths.

Missing Y Property Data

There are several reasons why a training item's property (Y) data could be unavailable. In the context of researching properties of molecules, Y data typically requires extensive experimentation and analysis, which can be expensive, time-consuming, and subject to various regulations. A common example is that in the early stages of a new project, often there is little data available on molecular interactions with the target of interest but a large quantity of data available on molecular interactions with different but related targets, such as isoforms. A model based on a training set of only molecules for which the Y property for the new target has been determined, and which has for an output just one Y variable representing the new target, is likely to be poorly determined and have poor prediction accuracy on molecules not yet measured. By accommodating missing Y data, the methods of the invention allow all of the older data to be used. In these embodiments, property information related to the old and better characterized target appears in the model as an additional Y variable, and the large set of molecules for which the Y property is only known for the old target may be used in the neural network training set. Note that the weights in the hidden layers affect the quality of the prediction of each Y and are determined by all of the Y data. This explains how adding another Y variable which is not of primary interest to a neural network model can be of benefit.

A multiphysical model can also benefit from accommodating missing Y data. For example it is often the case that limited toxicity or solubility data is available on molecules for which biological activity has been determined.

In some embodiments, a training set containing some items with missing Y property data is accommodated by omitting from the error function sum (F) and its derivative set forth in Equations 5 and 8 above any contribution from an output which corresponds to missing Y property data. During the training process, both known and missing Y properties are predicted from the X descriptor inputs; however, when connection weights are adjusted, only the error in prediction of the known Y properties is considered because the output error Y′ᵢ−Yᵢ is considered zero whenever the particular Yᵢ is unknown.

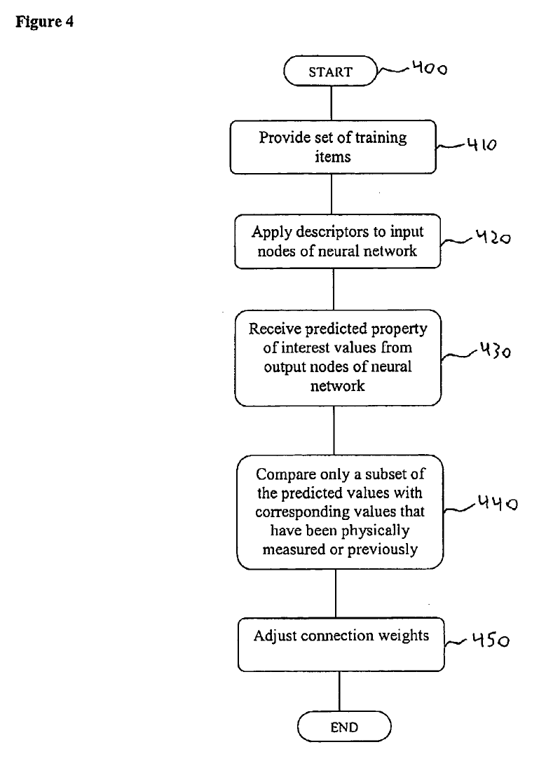

One such embodiment is illustrated by the flowchart depicted in FIG. 4. The training process starts at start block 400. At block 410, a set of training items containing physically measured or previously determined X descriptors and physically measured or previously determined values for at least some properties of interest is provided to the neural network for training. At block 420, the X descriptors are applied to the input nodes of the neural network. At block 430, predicted values for all of the properties of interest are received at the output nodes of the neural network. A subset of the predicted values are compared to the corresponding physically measured or previously determined values at block 440. In one embodiment, the subset of predicted values is coextensive with all predicted values that have corresponding physically measured or previously determined values. At block 450, the connection weights of the neural network are adjusted based on the comparison in block 440. In some embodiments, the processes in blocks 430 to 450 are repeated as described above to optimize the neural network.

In one embodiment the “miscalculation cost” Cᵢ is chosen to be inversely proportional to the number of known values.

Missing X Descriptor Data

As with Y property data, there are several reasons why X descriptor data might be missing from particular items. For example, descriptor data might be unavailable because of difficulty in making certain calculations or because making particular measurements is prohibitively expensive.

In one embodiment, missing descriptor data can be accommodated by providing initial estimates for missing items from random numbers generated with (roughly) the same distribution as the rest of the (non-missing) data set. It is one aspect of the invention that the initial estimates are iteratively updated to find self-consistent final estimates of the missing data. When a set of training items contains items that have missing descriptor data, the result of the training process is an optimization of both the connection weights and estimates for the missing descriptor data.

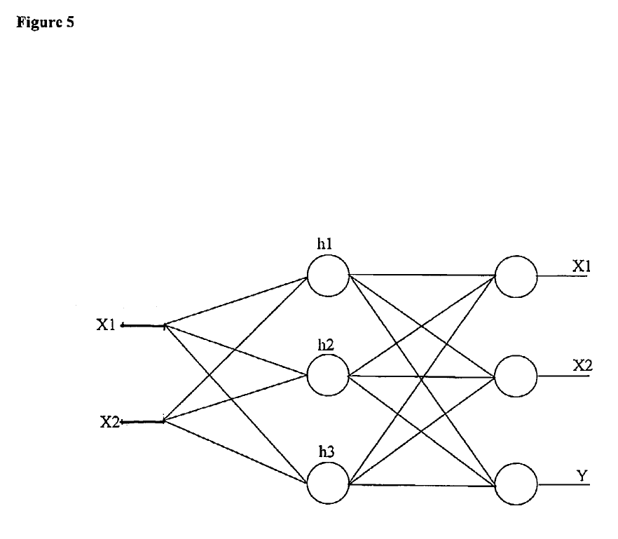

In one embodiment, optimization of initial estimates for missing descriptor data is accomplished by using a replicated neural network architecture. In a replicated architecture, which is known in the art, input descriptors are replicated in output nodes. Thus, the output layer of the neural network will contain nodes for both the properties of interest as well as at least some of the descriptors. This type of architecture is illustrated in FIG. 5. The neural network depicted in FIG. 5 contains input nodes for two descriptors, X1 and X2. The output layer contains a node for one property of interest (Y) as well as replicated nodes for the X1 and X2 descriptors. In the embodiment shown in FIG. 5, there is also one hidden layer with three nodes. During the training process, values are produced for the X1 and X2 output nodes as well as for the Y property of interest.

In order to handle a training set where some items are missing X1 and X2 descriptor data, initial estimates of any missing data can be updated each cycle during training by making use of the node error term for the input layer, δ₁ᵢ for each unknown Xᵢ as a correction, together with adding a “self-consistency” term to the objective function F. The replicated values for unknown descriptors are treated the same way as is described above for missing Y data: the error between the replicated value and the estimated descriptor is not used in the training process. However, the back propagation process will still produce a local error value δ₁ᵢ which corresponds to the originally estimated descriptor value. The δ₁ᵢ quantity is produced during conventional back propagation of error training techniques but is normally not used during this process since the values of known X's are fixed. In some embodiments of the invention, however, the δ₁ᵢ value is added to the estimated value with each iteration to produce successively “corrected” estimates of the missing descriptor. When training is complete, a set of values for the missing X data is produced that, while not uniquely determined, is consistent with both the neural net model generated and the rest of the data in the training set.

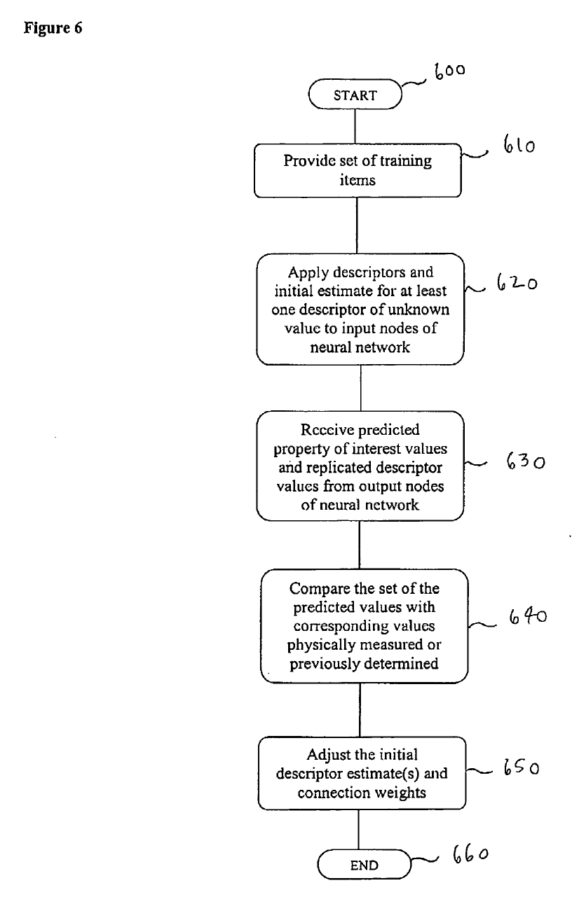

One embodiment of the neural network training process using training items that contain missing descriptor data is illustrated by the flowchart depicted in FIG. 6. The process starts at start block 600. At block 610 a set of training items containing some known descriptor values and some unknown descriptor values and known values are provided to the neural network. Properties of interest (Y variables) may be known for all training items, or some training items with one or more unknown properties may be used. At block 620, descriptors that have been physically measured or previously determined and also unknown descriptors that have been estimated are applied to the corresponding input nodes of the neural network. At block 630, predicted property values and replicated descriptor values are received at the output nodes. At block 640, replicated descriptor values and predicted values for the properties of interest are compared with the corresponding known values. Errors in unknown values are ignored as described above. At block 650, the connection weights and current estimates for the descriptors that have not been physically measured or otherwise previously determined are adjusted using error back propagation as described above. The processes can be repeated to provide iterative adjustment of missing descriptor estimates and neural network connection weights.

As described above, a test set can be used to objectively monitor the error of the neural network to determine the appropriate time to stop training. If the test set includes unknown descriptors, the test set can be run through the network during training to optimize the estimates for unknown test set descriptors. During this process of optimizing unknown test set descriptors, Y property prediction errors of the test set are not considered during back propagation. However, when using the test set for monitoring error in the neural network, predictions for replicated descriptors are ignored. Only the predicted Y properties are compared to known values to monitor error.

In one embodiment, an algorithm for accommodating missing descriptor values is as follows:

1. Insert random guesses for unknown descriptor values (these can be chosen from a normal distribution centered on the mean of the known descriptor values with half variance).

2. Use a replicator network architecture to avoid simply encoding the Y property values in the (potentially many) unknown descriptor values.

3. Add the term

Σ_{unknowns in training set} (X−X′)²

to the objective function F, representing a contribution corresponding to “self-consistency” of the estimates for the unknowns.

4. Treat replicated unknown descriptor values as missing Y property data, using the algorithm discussed above for accommodating missing Y property data.

5. Add descriptor items from the test set to the training set with the Y property values deleted, again using the missing Y property algorithm. This allows missing items in the test set as well.

6. Update the guesses iteratively along with the weights during the training process. For example, if there are 100 unknown descriptor values and 20 connection weights, there are 120 parameters; at the end of the process, there would be estimates for the 100 descriptor values and there would be optimized values for the 20 connection weights. The derivative of the modified objective function F with respect to an unknown Xᵢ is given by:

−δ₁ᵢ+2(Xᵢ−X′ᵢ)

where X′ᵢ is the replicated estimation of Xᵢ

7. Delete all terms in the sums in the expression for the derivative of F with respect to weights in which Z_{1-l,j} corresponds to an unknown descriptor value. This avoids coupling the value of the connection weights too strongly with the current (possibly poor) estimate of the unknown descriptor values.

The procedures and algorithms for handling missing X descriptor and missing Y property data may be used together such that training sets containing both missing descriptor and Y property values can be used to train a neural network.

Testing New Items

After a neural network has been constructed and trained, it can be used for prediction of the Y properties of new, untested items. In some cases, descriptor data may be missing from some of the new items. In one embodiment, a procedure for accommodating missing descriptor data in new items for which prediction is desired is as follows:

1. Consider one item at a time.

2. If there is no missing descriptor data, proceed with that item as normal.

3. If one or more descriptors are missing in an item, generate an initial estimate based on the mean of the known values in a set of other items.

4. Keep the connection weights frozen and iteratively improve the estimates for the missing descriptors while minimizing the error in predictions made in the replicated descriptor nodes.

This process can be used in an “inverse QSAR” process, where descriptors that are consistent with some desired property can be determined from a trained neural network. In this technique, a trained neural network can be provided with random choices, guesses, or estimates for a set of descriptors. Keeping the connection weights frozen, the output property error between the predicted value to the desired value is back propagated as described above, and each δ_{1I} value is used to provide a correction to the respective input descriptors. This process is iterated until a set of descriptor values consistent with the desired property is determined.

This use of a trained neural network is especially valuable in the context of neural networks used to predict the properties of chemical formulations. In this application, the descriptors are typically values for amounts of particular ingredients or numerical processing parameters, and the properties are attributes or characteristics of the final material such as hardness, specific gravity, color, catalytic efficiency, or the like. Using this inverse QSAR process, it is possible to produce a set of parameters that are consistent with a desired property from a neural network.

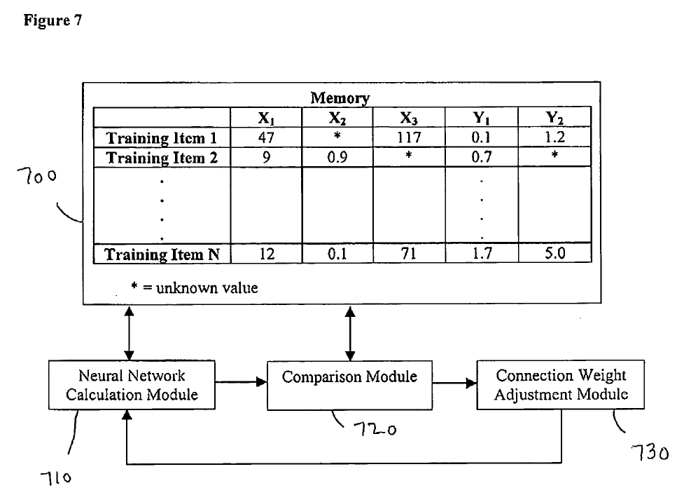

In one embodiment, illustrated in FIG. 7, a computer-implemented system is provided for training a neural network. As will be understood by those of skill in the art, the methods described herein can be implemented on general purpose computer systems with well known components such as processing circuitry, memory, input devices, displays, etc.

In this embodiment, a memory 700 is provided for storing a set of descriptors and a set of values for properties of interest for a set of training items. A first subset of items has incomplete descriptor and/or property information. Training items 1 and 2 in the example table stored in the memory of FIG. 7 would fall into this first subset. All of the descriptors and properties of interest for a second subset of items have been physically measured or previously determined. In FIG. 7, the table stored in memory includes training item N, which has a complete set of descriptor and property information. Training item N would thus be in this second subset. This second subset may have no items, such that every training item is missing at least one descriptor or property value. The neural network calculation module 710 receives as input the set of descriptors for the set of items and calculates output predictions for all properties of interest and any replicated descriptors which are part of the network architecture. A comparison module 720 is connected to both memory 700 and neural network calculation module 710. The comparison module 720 compares the predicted values for the properties of interest and replicated descriptors with corresponding known values for the set of training items. The comparison module 720 is connected to a connection weight adjustment module 730. The connection weight adjustment module 730 adjusts the connection weights of the neural network based on the results of the comparison module 720.

In one embodiment, the computer-implemented system above also contains an initial estimate module connected to the memory 700 and the neural network calculation module 710. The initial estimate module operates to provide initial estimates to the neural network calculation module 710 for descriptor values not stored in memory 700. In this embodiment, the connection weight adjustment module 730 also adjusts the initial estimates based on the results of the comparison module 720.

### EXAMPLE 1

An exclusive-or (XOR) problem was designed to test the ability of the neural network training processes described herein to handle missing descriptor and property data. 400 items in the problem were assigned an X₁ value between 0 and 1, and an X₂ value between 0 and 1, and a categorical Y value of either exactly 1 or exactly 0. In this example, items were assigned a Y value of 1 if either X₁ or X₂ was greater than 0.5 but not if both X₁ and X₂ were greater than 0.5. This is known as the exclusive-or problem.

Training of a neural network to solve an XOR problem was conducted using 400 training items. Each item had one X value or the Y value deleted at random such that no item had a complete set of data. Overall, there were 265 unknown X values and 135 unknown Y values. Results indicated that the neural network provided correct predictions for 97% of the training data and 92% of test data. Large sampling indicated that 97.3% is the theoretically best possible prediction rate for this example.

Although this example does not use actual physical descriptors and properties corresponding to actual molecular structures, it demonstrates that neural network training remains stable and accurate even with missing descriptor and property information.

### EXAMPLE 2

404 molecules were physically tested for inhibition of Cox1 and Cox2. For purposes of neural network training, two properties of interest (Y variables) were defined: inhibition of Cox1 and inhibition of Cox2. In training the neural network, 354 of the molecules had their inhibition of Cox2 data deleted such that 354 of the training items had data only for the Cox1 property of interest. The remaining 50 training items retained data for both Cox1 and Cox2 inhibition. After training was complete, results indicated that the neural network correctly predicted Cox2 inhibition on a test set 75% of the time, despite the large number of training items that contained no Cox2 data.

To compare the new method with a traditional method, a neural network was trained using only the 50 training items that had both Cox1 and Cox2 data. Only the Cox2 inhibition Y variable was used. The result on a test set consisting of the remaining 354 items indicated that Cox2 inhibition was correctly predicted 62% of the time. Thus, the results indicate that including molecules that had Cox2 inhibition data deleted during neural network training improved prediction accuracy by 13%.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A method of constructing a neural network comprising a set of property prediction outputs and a set of descriptor inputs, said method comprising updating connection weights of said neural network using a training set of physical items, wherein at least some of said physical items of said training set have one or more undefined properties corresponding to at least one output of said neural network.

2. The method of claim 1, wherein at least some of said physical items of said training set have one or more undefined descriptors corresponding to at least one input of said neural network.

3. The method of claim 2, additionally comprising optimizing estimates for undefined descriptors of said training set of physical items.

4. A method of training a neural network, the neural network operating to provide predictions of at least one attribute of interest of a physical item, wherein the physical item has one or more measured or computed descriptors representative of one or more physical characteristics of the physical item, and wherein the physical item has one or more unknown properties of interest which have not been physically measured or otherwise previously determined, the neural network comprising a plurality of layers, each layer comprising one or more nodes, wherein the first layer comprises one or more input nodes that are configured to receive as input the one or more descriptors, wherein the last layer comprises one or more output nodes that are configured to output predictions of values for the one or more unknown properties of interest, and wherein one or more layers between the first and last layers comprise one or more hidden nodes, each hidden node in a layer receiving as input the output of nodes in the immediately preceding layer and producing as output the result of a function of the output of nodes in the immediately preceding layer and one or more connection weights, the method comprising:
providing a set of training items, said items comprising one or more physically measured or previously determined descriptors representing physical characteristics of said items, and one or more physically measured or previously determined values for one or more properties of interest;
applying said one or more physically measured or previously determined descriptors of said set of items to said input nodes of said neural network;
receiving as output from said output nodes a set of predicted values for properties of said set of training items;
comparing only a subset of said set of predicted values with corresponding values in said physically measured or previously determined values; and
adjusting said connection weights based at least in part on said comparing.

5. The method of claim 4, wherein said compared subset consists of each predicted value that has a corresponding physically measured or previously determined value.

6. A method of training a neural network, the neural network operating to provide predictions of at least one attribute of interest of a physical item, wherein the physical item has one or more measured or computed descriptors representative of one or more physical characteristics of the physical item, and wherein the physical item has one or more unknown properties of interest which have not been physically measured or otherwise previously determined, the neural network comprising a plurality of layers, each layer comprising one or more nodes, wherein the first layer comprises one or more input nodes that are configured to receive as input the one or more descriptors, wherein the last layer comprises one or more output nodes that are configured to output predictions of values for the one or more unknown properties of interest, and wherein one or more layers between the first and last layers comprise one or more hidden nodes, each hidden node in a layer receiving as input the output of nodes in the immediately preceding layer and producing as output the result of a function of the output of nodes in the immediately preceding layer and one or more connection weights, the method comprising:
providing a set of training items, said items comprising one or more physically measured or previously determined descriptors representing physical characteristics of said items, and one or more physically measured or previously determined values for one or more properties of interest;
applying said one or more physically measured or previously determined descriptors of said set of items to said input nodes of said neural network;
applying an initial estimate for a descriptor corresponding to a characteristic of an item in said set of training items to one of said input nodes;
receiving as output from said output nodes a set of predicted values for properties of the set of training items;
comparing said set of predicted values with corresponding values in said one or more physically measured or previously determined values; and
adjusting said initial estimate based at least in part on said comparing.

7. A method of predicting values for one or more properties of interest of a physical item, the properties of interest representing physical properties of the item, the item comprising a plurality of descriptors representing one or more physical characteristics of the item, the method comprising:
providing a neural network configured to receive as input values for said plurality of descriptors and provide as output values for said one or more properties of interest;
providing to said neural network measured or computed values for at least one of said plurality of descriptors,
estimating values for one or more other of said plurality of descriptors have not been physically measured or otherwise previously determined and providing said estimates to said neural network;
receiving as output from said neural network predicted values for said one or more properties of interest and said plurality of descriptors; and
adjusting said estimates for said plurality of descriptors that have not been physically measured or otherwise previously determined using one or more of said outputs.

8. The method of claim 7 further comprising iteratively performing the receiving and adjusting acts to optimize said estimates.

9. A computer implemented system for training a neural network for predicting one or more properties of interest of a physical item, said system comprising:
a memory storing a set of descriptors and a set of values for said properties of interest for a subset of a set of training physical items, wherein said set of descriptors and said set of values for said properties were physically measured or previously determined, said memory also storing at least one descriptor and values for at least one property of interest for at least one of said set of training items not part of said subset, wherein at least one property of said at least one training item is not stored in said memory;
a neural network calculation module operative to receive as input said set of descriptors and calculate predicted values for said properties of interest;
a comparison module operative to compare said predicted values with corresponding ones of said set of physically measured or previously determined values for at least one property; and
a connection weight adjustment module operative to adjust connection weights of said neural network based on output from said comparison module.

10. The system of claim 9 further comprising an initial estimate module operative to provide initial estimates for at least one descriptor not stored in said memory as input to said neural network calculation module and wherein said connection weight adjustment module is operative to adjust said initial estimate based on output from said comparison module.

11. A method of predicting a set of pre-defined characteristics of formulations that are likely to exhibit a desired property comprising:
providing a neural network trained to predict the existence of said desired property given a value for each of said set of pre-defined characteristics;
providing value estimates for each of said set of pre-defined characteristics so as to produce a predicted property from said neural network,
back propagating an error between said predicted property and said desired property to produce a correction value for said value estimates;
adjusting said value estimates based on said correction value.

12. The method of claim 11, comprising iterating said providing value estimates, back propagating, and adjusting steps to produce an optimized set of pre-defined characteristics.
